(19) United States
(12) Patent Application Publication
(10) Pub. No.: US 2023/0291654 A1
(43) Pub. Date: Sep. 14, 2023

(54) NETWORK APPARATUS, CONTROL METHOD, AND COMPUTER-READABLE MEDIUM

(71) Applicant: NEC Corporation, Minato-ku, Tokyo (JP)

(72) Inventors: Hiroyuki Toyama, Tokyo (JP); Hisanao Funakou, Tokyo (JP); Yoichiro Ito, Tokyo (JP); Hisashi Mizumoto, Tokyo (JP); Hiroaki Miyoshi, Tokyo (JP)

(73) Assignee: NEC Corporation, Minato-ku, Tokyo (JP)

(21) Appl. No.: 18/015,914

(22) PCT Filed: Jul. 22, 2020
(86) PCT No.: PCT/JP2020/028464

§ 371 Date: Jan. 12, 2023

(51) Int. Cl. H04L 41/12; H04L 12/46

(52) U.S. Cl. CPC H04L 41/12; H04L 12/4641

(57) ABSTRACT

A network apparatus (2000) includes a port (20). A target apparatus (10) is connected to the port (20). The network apparatus (2000) computes a communication feature value related to communication between the target apparatus (10) and the port (20). The network apparatus (2000) determines whether a communication feature value computed for the target apparatus (10) and a communication feature value predetermined for a specific apparatus match each other. The network apparatus (2000) performs predetermined control processing when it is determined that the communication feature value for the target apparatus and the communication feature value for the specific apparatus do not match each other.

### TECHNICAL FIELD

The present invention relates to control of communication by a network apparatus.

### BACKGROUND ART

Communication via a network has been frequently used. In such network communication, a system for detecting connection of an unauthorized apparatus to the network has been developed.

For example, Patent Literature 1 discloses a technique of detecting addition or removal of a machine to or from a bus line. This system flows a signal at each of a plurality of frequencies through the bus line to which the machine is connected, checks magnitude of a voltage drop, and thus detects a resonance frequency. Herein, when the machine is added to the bus line or the machine connected to the bus line is removed, the resonance frequency changes. Thus, the system detects addition or removal of the machine to or from the bus line by detecting a change in the resonance frequency in the bus line. Further, Patent Literature 2 discloses a technique of detecting connection of an unauthorized apparatus by comparing a change over time or a distance transition of a voltage value in a bus line or a change over time or a distance transition of an impedance value with those in a normal condition.

### CITATION LIST

### Patent Literature

[Patent Literature 1] Japanese Unexamined Patent Application Publication No. 2007-036512
[Patent Literature 2] International Patent Publication No. WO2018/146845

### SUMMARY OF INVENTION

### Technical Problem

The inventions in Patent Literatures 1 and 2 perform detection of an unauthorized apparatus when addition of a change to a network configuration is detected. Thus, even when an authorized apparatus permitted to be used is added, the addition is detected as connection of an unauthorized apparatus.

The present invention has been made in view of the problem described above, and one of objects of the present invention is to provide a technique for determining whether an apparatus connected to a network is an authorized apparatus.

### Solution to Problem

A network apparatus according to the present disclosure includes a port. The network apparatus includes: a computation unit configured to compute a communication feature value related to communication between the port and a target apparatus connected to the port; a determination unit configured to determine whether a communication feature value computed for the target apparatus and a communication feature value predetermined for a specific apparatus match each other; and a control execution unit configured to perform predetermined control processing when it is determined that the communication feature value for the target apparatus and the communication feature value for the specific apparatus do not match each other.

A control method according to the present disclosure is executed by a network apparatus including a port. The control method includes: a computation step of computing a communication feature value related to communication between the port and a target apparatus connected to the port; a determination step of determining whether a communication feature value computed for the target apparatus and a communication feature value predetermined for a specific apparatus match each other; and a control execution step of performing predetermined control processing when it is determined that the communication feature value for the target apparatus and the communication feature value for the specific apparatus do not match each other.

A computer readable medium according to the present disclosure stores a program causing a computer to execute the control method according to present disclosure.

### Advantageous Effects of Invention

The present invention provides a technique capable of determining whether an apparatus connected to a network is an authorized apparatus.

### BRIEF DESCRIPTION OF DRAWINGS

FIG. 1 is a diagram illustrating an overview of a network apparatus according to a first example embodiment;

FIG. 2 is a block diagram illustrating a functional configuration of the network apparatus;

FIG. 3 is a block diagram illustrating a hardware configuration of a computer that achieves the network apparatus; and

FIG. 4 is a flowchart illustrating a flow of processing performed by the network apparatus according to the first example embodiment.

### EXAMPLE EMBODIMENT

Hereinafter, example embodiments of the present disclosure will be described in detail with reference to drawings. In each of the drawings, the same or corresponding elements will be denoted by the same reference signs, and duplicate description will be omitted depending on need for the sake of clarity of explanation.

### First Example Embodiment

### <Overview>

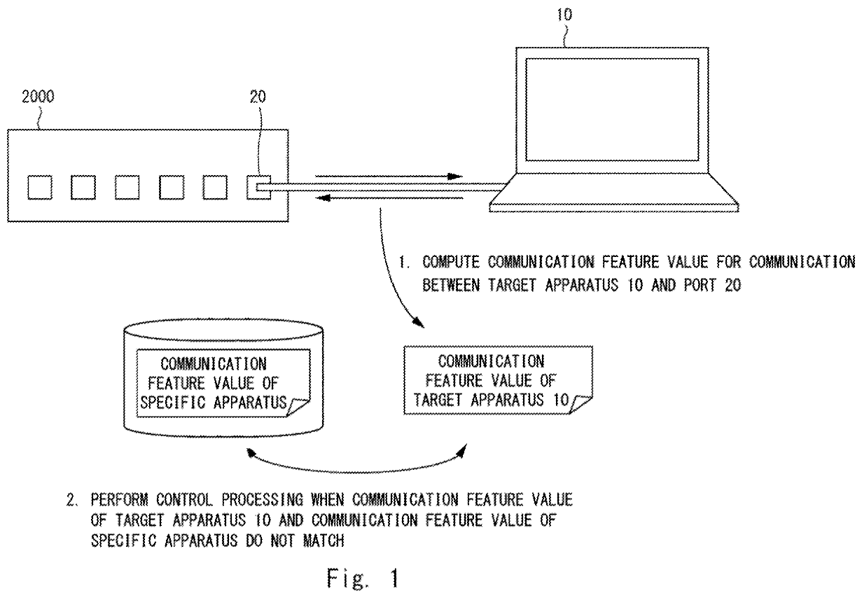

FIG. 1 is a diagram illustrating an overview of a network apparatus 2000 according to a first example embodiment. Note that the following description with reference to FIG. 1 is for facilitating understanding of the network apparatus 2000 according to the first example embodiment, and an operation of the network apparatus 2000 according to the first example embodiment is not limited to an operation in the following description.

The network apparatus 2000 includes a plurality of ports 20. For example, the network apparatus 2000 is a layer 2 switch, a layer 3 switch, a router, or the like. An apparatus having a function of performing network communication is connected to the port 20. Hereinafter, an apparatus connected to the port 20 is referred to as a target apparatus 10. For example, the port 20 is a local area network (LAN) port. In this case, the target apparatus 10 and the port 20 are connected to each other by a LAN cable.

The network apparatus 2000 computes a feature value for communication between the target apparatus 10 and the port 20. Hereinafter, the feature is referred to as a communication feature value. For example, the communication feature value is information representing a feature related to a response time for a predetermined command being transmitted from the network apparatus 2000 to the target apparatus 10 and a feature related to an electric signal being observed by the port 20.

Herein, for one or more apparatuses (hereinafter, specific apparatuses) permitted to be connected to the network apparatus 2000, a communication feature value acquired when the apparatus is connected to the port 20 is known in advance. For example, computation of a communication feature value is performed by actually connecting the port 20 to the network apparatus 2000 or another network apparatus, and the computed communication feature value is stored in advance in a storage device that can be accessed from the network apparatus 2000. The network apparatus 2000 determines whether the communication feature value being computed for the target apparatus 10 matches the communication feature value for the specific apparatus (for example, whether a degree of similarity therebetween is equal to or more than a threshold value).

When the communication feature value being computed for the target apparatus 10 does not match the communication feature value for the specific apparatus, it is clear that the target apparatus 10 is not the specific apparatus. Then, when the communication feature value being computed for the target apparatus 10 does not match the communication feature value for the specific apparatus, the network apparatus 2000 performs predetermined control processing for the port 20. For example, the control processing may be processing of cutting off communication between the target apparatus 10 and another apparatus that is performed via the port 20. On the other hand, when the communication feature value being computed for the target apparatus 10 matches the communication feature value for the specific apparatus, the control processing described above is not performed.

### Example of Advantageous Effect

The network apparatus 2000 according to the present example embodiment computes a communication feature value for the target apparatus 10 of the network apparatus 2000, and determines whether that communication feature value matches a communication feature value of a specific apparatus. In this way, by performing matching with a communication feature value of an authorized apparatus, whether an apparatus added to a network is an authorized apparatus or an unauthorized apparatus can be determined. Further, when it is determined that the communication feature value being computed for the target apparatus 10 does not match the communication feature value of the specific apparatus, the control processing is performed. In this way, instead of uniformly limiting addition of an apparatus to a network, addition of an unauthorized apparatus can be limited while addition of an authorized apparatus is permitted. Thus, security of a network can be improved while enabling a change of a configuration of the network.

Hereinafter, the network apparatus 2000 according to the present example embodiment will be described in more detail.

### <Example of Functional Configuration>

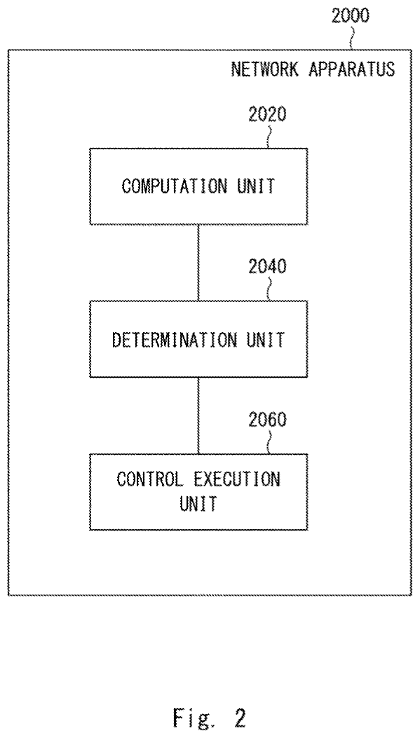

FIG. 2 is a block diagram illustrating a functional configuration of the network apparatus 2000. The network apparatus 2000 includes a computation unit 2020, a determination unit 2040, and a control execution unit 2060. The computation unit 2020 computes a communication feature value for the target apparatus 10 connected to the port 20. The determination unit 2040 determines whether the computed communication feature value matches a communication feature value of a specific apparatus. The control execution unit 2060 performs predetermined control processing when the computed communication feature value does not match the communication feature value of the specific apparatus.

### <Example of Hardware Configuration>

Each functional component unit of the network apparatus 2000 may be achieved by hardware (for example, a hard-wired electronic circuit, and the like) that achieves each functional component unit, and may be achieved by a combination of hardware and software (for example, a combination of an electronic circuit and a program that controls the electronic circuit, and the like). Hereinafter, a case where each functional component unit of the network apparatus 2000 is achieved by the combination of hardware and software will be further described.

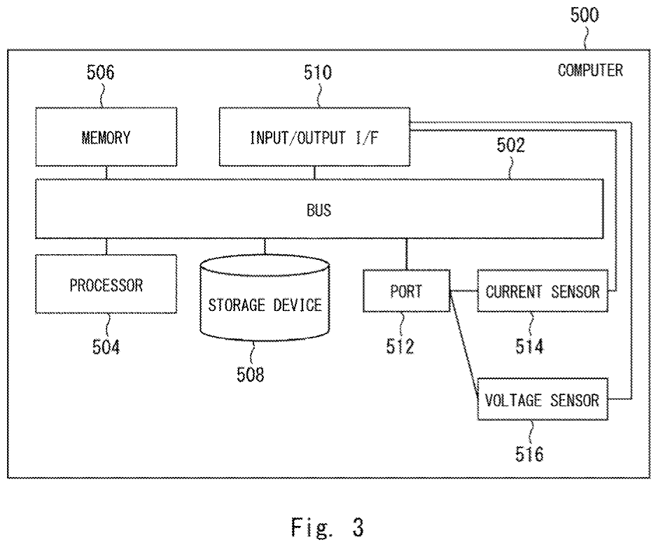

FIG. 3 is a block diagram illustrating a hardware configuration of a computer 500 that achieves the network apparatus 2000. The computer 500 is arbitrary computer. For example, the computer 500 is a special-purpose computer with which a network apparatus such as a switch is realized. In addition, for example, the computer 500 may be a general-purpose computer such as a personal computer (PC) or a server machine.

For example, each function of the network apparatus 2000 is achieved in the computer 500 by installing a specific application into the computer 500. The application described above is formed of a program for achieving each functional component unit of the network apparatus 2000.

The computer 500 includes a bus 502, a processor 504, a memory 506, a storage device 508, an input/output interface 510, and a port 512. The bus 502 is a data transmission path for allowing the processor 504, the memory 506, the storage device 508, the input/output interface 510, and the port 512 to transmit and receive data with one another. However, a method for connecting the processor 504 and the like to one another is not limited to bus connection.

The processor 504 is various types of processors such as a central processing unit (CPU), a graphics processing unit (GPU), or a field-programmable gate array (FPGA). The memory 506 is a main storage device achieved by using a random access memory (RAM) and the like. The storage device 508 is an auxiliary storage device achieved by using a hard disk, a solid state drive (SSD), a memory card, a read only memory (ROM), or the like.

The input/output interface 510 is an interface for connecting the computer 500 and an input/output device. For example, an input device such as a keyboard and an output device such as a display device are connected to the input/output interface 510.

The port 512 is an interface for connecting the computer 500 to a network, and corresponds to the port 20 described above. Note that, although not illustrated, a plurality of the ports 512 are provided in reality.

When a feature of an electric signal in the port 20 is used as a communication feature value, the network apparatus 2000 includes a current sensor 514 for measuring magnitude of a current for the electric signal flowing through each port 512, and a voltage sensor 516 for measuring magnitude of a voltage. In FIG. 3, both of the current sensor 514 and the voltage sensor 516 are connected to the input/output interface 510. Thus, a value being measured by the sensors can be referred via the input/output interface 510. Further, setting may be performed in advance so that value measured by the sensors are automatically put into the memory 506 or the storage device 508. Note that an existing technique can be used as a specific technique of measuring magnitude of a current and magnitude of a voltage for a port.

The storage device 508 stores a program (a program that achieves the application described above) that achieves each functional component unit of the network apparatus 2000. The processor 504 reads the program onto the memory 506 and executes the program, and thus each functional component unit of the network apparatus 2000 is achieved. Further, a communication feature value of a specific apparatus is stored in advance in the storage device 508.

### <Flow of Processing>

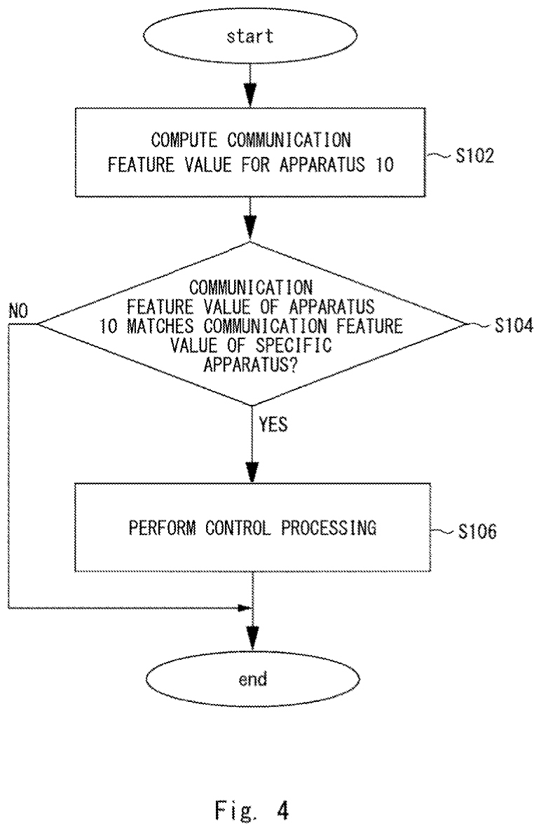

FIG. 4 is a flowchart illustrating a flow of processing performed by the network apparatus 2000 according to the first example embodiment. The computation unit 2020 computes a communication feature value for the target apparatus 10 connected to the port 20 (S102). The determination unit 2040 determines whether the computed communication feature value matches a communication feature value of a specific apparatus (S104). The control execution unit 2060 performs predetermined control processing when the computed communication feature value does not match the communication feature value of the specific apparatus (S106).

### <Computation of Communication Feature Value: S102>

The computation unit 2020 computes a communication feature value for the target apparatus 10 (S102). For example, the communication feature value is one or more pieces of: 1) information representing a feature of a response time for a predetermined command being transmitted from the port 20 to the target apparatus 10; and 2) information representing a feature of an electric signal being observed by the port 20. Hereinafter, a computation method for the two examples will be described.

### <<1) Response Time of Command>>

When a feature of a response time for a predetermined command is used as a communication feature value, the computation unit 2020 transmits the predetermined command to the target apparatus 10, and measures a response time thereof. Then, a communication feature value based on the response time is computed. For example, the communication feature value is a statistical value (such as an average value or a medium value) that is computed from the response times of a command that is sent a plurality of times. Not that, a measurement of a response time may be performed only once to use this response time as the communication feature value.

A command to be transmitted from the computation unit 2020 to the target apparatus 10 is a command to which the target apparatus 10 that receives the command returns a response. There are various commands to be transmitted from the computation unit 2020 to the target apparatus 10. Examples of the commands include a bridge protocol data unit (BPDU) command, a link layer discovery protocol (LLDP) command, a cisco discovery protocol (CDP) command, or the like. An existing technique can be used for a measurement itself of a response time for the commands.

### <<2) Feature of Electric Signal>>

As a feature of an electric signal flowing through the port 20, a feature of a waveform of magnitude of a current, a feature of a waveform of magnitude of a voltage of the electric signal, a range of magnitude of power consumption, and the like can be used. Suppose that a feature of a waveform of magnitude of a current in the port 20 is used as a communication feature value. In this case, the computation unit 2020 acquires time series data about magnitude of a current being measured by the current sensor 514, analyzes the time series data, and thus computes a communication feature value representing a feature of a waveform of the magnitude of the observed current. For example, in this case, the communication feature value is the magnitude of an amplitude, the frequency, the cycle, or the like of the waveform of the current.

Suppose that a feature of a waveform of magnitude of a voltage in the port 20 is used as a communication feature value. In this case, the computation unit 2020 acquires time series data about magnitude of a voltage being measured by the voltage sensor 516, analyzes the time series data, and thus computes a communication feature value representing a feature of a waveform of the magnitude of the observed voltage. For example, in this case, the communication feature value is the magnitude of an amplitude, the frequency, the cycle, or the like of the waveform of the voltage.

Suppose that a range of magnitude of power consumption in the port 20 is used as a communication feature value. In this case, the computation unit 2020 acquires time series data about magnitude of a current being measured by the current sensor 514 and time series data about magnitude of a voltage being measured by the voltage sensor 516. Furthermore, the computation unit 2020 generates time series data about power consumption in the port 20 by using the pieces of the time series data. Then, the computation unit 2020 computes a communication feature value representing a range of magnitude of power by using the time series data about the power consumption. For example, the communication feature value is a pair of minimum power and maximum power, or a difference between the minimum power and the maximum power.

### <Matching of Communication Feature Value: S104>

The determination unit 2040 determines whether the communication feature value of the target apparatus 10 matches a communication feature value of a specific apparatus (S104). To achieve this, information that determines the communication feature value of the specific apparatus is prepared and stored in advance in a storage device that can be accessed from the determination unit 2040. Note that the specific apparatus is not limited to one, and may be plural. In the latter case, a plurality of apparatuses that may be connected to the network apparatus 2000 are predefined. When there are the plurality of specific apparatuses, a communication feature value of each of the specific apparatuses is stored in advance in the storage device described above.

The determination unit 2040 may determine that a communication feature value of the target apparatus 10 and a communication feature value of a specific apparatus match each other when the communication feature values are equal to each other, or may determine that the communication feature values match each other when a degree of similarity between the communication feature values is high. As a value representing a degree of similarity between two communication feature values, for example, a ratio of the communication feature value of the target apparatus 10 to the communication feature value of the specific apparatus can be used. In this case, it can be said that the closer the ratio is, the higher a degree of similarity between the two communication feature values. Thus, when the ratio falls within a predetermined range including 1, the determination unit 2040 determines that a degree of similarity between the two communication feature values is high. On the other hand, when the ratio is outside the predetermined range described above, the determination unit 2040 determines that a degree of similarity between the two communication feature values is not high. For example, the predetermined range can be represented by a<ratio r<b (a<1 and b>1).

Note that, as in a case where a pair of a minimum value and a maximum value of magnitude of power is handled as a communication feature value, the communication feature value may be formed of a plurality of values. In this case, for example, for a communication feature value of the target apparatus 10 and a communication feature value of a specific apparatus, the determination unit 2040 computes ratios between corresponding values, and determines that the two communication feature values match each other when all degrees of similarity between the computed ratios are high. As a specific example, when both a “ratio of the maximum power indicated by a communication feature value of the target apparatus 10 to the minimum power indicated by a communication feature value of a specific apparatus” and a “ratio of the maximum power indicated by the communication feature value of the target apparatus 10 to the maximum power indicated by the communication feature value of the specific apparatus” fall in a predetermined range including 1, the determination unit 2040 determines that the communication feature value of the target apparatus 10 and the communication feature value of the specific apparatus match each other.

Note that, when a plurality of specific apparatuses are present, for example, the determination unit 2040 determines whether a specific apparatus having a communication feature value that matches a communication feature value of the target apparatus 10 is present. Then, when the specific apparatus having the communication feature value that matches the communication feature value of the target apparatus 10 is present (i.e., when the communication feature value of the target apparatus 10 matches the communication feature value of at least one specific apparatus), the determination unit 2040 determines that the communication feature value of the target apparatus 10 matches the communication feature value of the specific apparatus. On the other hand, when the specific apparatus having the communication feature value that matches the communication feature value of the target apparatus 10 is not present (i.e., when the communication feature value of the target apparatus 10 does not match the communication feature value of any of the specific apparatuses), the determination unit 2040 determines that the communication feature value of the target apparatus 10 does not match the communication feature value of the specific apparatus.

### <Execution of Control Processing: S106>

When it is determined that the communication feature value of the target apparatus 10 does not match the communication feature value of the specific apparatus (S104: NO), the control execution unit 2060 performs predetermined control processing (S106). For example, the predetermined control processing is processing of limiting communication being performed by the target apparatus 10 via the port 20. Specifically, the control execution unit 2060 cuts off communication being performed by the target apparatus 10 with another apparatus via the port 20. Specifically, when the target apparatus 10 attempts to transmit data to another apparatus via the port 20, the control execution unit 2060 controls an operation of the network apparatus 2000 in such a way that the network apparatus 2000 does not transmit the data to the outside. Further, when data are transmitted from another apparatus to the target apparatus 10 via the port 20, the control execution unit 2060 controls an operation of the network apparatus 2000 in such a way that the network apparatus 2000 does not transmit the data to the target apparatus 10.

Note that only a part of communication may be limited instead of limiting all communication via the port 20. For example, the control execution unit 2060 cuts off only a packet having a specific TCP port number or a specific UDP port number. In addition, for example, the control execution unit 2060 may control the network apparatus 2000 in such a way that the target apparatus 10 can perform communication with only another apparatus belonging to the same LAN (i.e., in such a way as to cut off communication between another apparatus belonging to another LAN and the target apparatus 10). In addition, for example, the control execution unit 2060 may control the network apparatus 2000 in such a way as to cut off communication between the target apparatus 10 and a specific apparatus (for example, an apparatus having a specific IP address) or a specific network.

For example, suppose that the network apparatus 2000 is installed in a house of an employee A who works at home. Then, suppose that the target apparatus 10 (for example, a PC) installed in the house of the employee A is connected to an in-house LAN of a company with a VPN (virtual private network) via the network apparatus 2000. In this case, the network apparatus 2000 is a VPN device (edge router) for achieving VPN communication, and establishes a VPN with the VPN device installed on the in-house LAN side. A specific apparatus is an apparatus (for example, a PC lent from the company) permitted to access the in-house LAN.

When the target apparatus 10 permitted to access the in-house LAN is connected to the network apparatus 2000, a communication feature value of the target apparatus 10 and a communication feature value of the specific apparatus match each other. Thus, the employee A can access the in-house LAN by using the target apparatus 10. On the other hand, when the target apparatus 10 not permitted to access the in-house LAN is connected to the network apparatus 2000, a communication feature value of the target apparatus 10 and a communication feature value of the specific apparatus do not match each other. Thus, the control processing by the network apparatus 2000 is performed. At this time, VPN connection with the in-house LAN is cut off as the control processing. In this way, it is possible to prevent the in-house LAN from being accessed by an employee who works at home using an apparatus not permitted to access the in-house LAN.

Note that, by limiting communication to be cut off to communication with the in-house LAN, the target apparatus 10 not permitted to access the in-house LAN can make access to something other than the in-house LAN (for example, access to a general web site, and the like) via the network apparatus 2000. Thus, it is possible not to limit an apparatus that can use the network apparatus 2000 to only a specific apparatus while limiting an apparatus that can be connected to the in-house LAN to only a specific apparatus. Thus, an improvement in convenience and an improvement in security can be both achieved.

Further, the control execution unit 2060 may transmit, to another device (for example, a terminal operated by a supervisor of the network apparatus 2000), a notification representing that an apparatus other than a specific apparatus is connected to the network apparatus 2000. Information representing a transmission destination of the notification is stored in advance in a storage device that can be accessed from the control execution unit 2060. In this way, a supervisor and the like can easily recognize a fact that an apparatus other than the specific apparatus is connected to the network apparatus 2000.

Although the invention of the present application has been described with reference to the example embodiments, it should be understood that the invention of the present application is not limited to the above-described example embodiments. Various modifications that can be understood by those skilled in the art can be made to the configuration and the details of the invention of the present application within the scope of the invention of the present application.

Note that, in the example described above, the program may be stored by using various types of non-transitory computer readable mediums, and may be provided to a computer. The non-transitory computer readable medium includes various types of tangible storage mediums. Examples of the non-transitory computer readable medium include a magnetic recording medium (for example, a flexible disk, a magnetic tape, and a hard disk drive), a magneto-optical recording medium (for example, a magneto-optical disk), a CD-ROM, a CD-R, a CD-R/W, and a semiconductor memory (for example, a mask ROM, a programmable ROM (PROM), an erasable PROM (EPROM), a flash ROM, and a RAM). Further, the program may be provided to the computer by various types of transitory computer readable mediums. Examples of the transitory computer readable medium include an electrical signal, an optical signal, and an electromagnetic wave. The transitory computer readable medium may supply the program to the computer via a wired communication path such as an electric wire and an optical fiber or a wireless communication path.

A part or the whole of the above-described example embodiments may also be described as in supplementary notes below, which is not limited thereto.

### (Supplementary Note 1)

A network apparatus including a port, comprising:
a computation unit configured to compute a communication feature value related to communication between the port and a target apparatus connected to the port;
a determination unit configured to determine whether a communication feature value computed for the target apparatus and a communication feature value predetermined for a specific apparatus match each other; and
a control execution unit configured to perform predetermined control processing when it is determined that the communication feature value for the target apparatus and the communication feature value for the specific apparatus do not match each other.

### (Supplementary Note 2)

The network apparatus according to Supplementary note 1, wherein the communication feature value represents a feature of a response time associated with a command that is transmitted from the network apparatus to the target apparatus.

### (Supplementary Note 3)

The network apparatus according to Supplementary note 1, wherein the communication feature value represents a feature of a waveform of magnitude of a current in the port.

### (Supplementary Note 4)

The network apparatus according to Supplementary note 1, wherein the communication feature value represents a feature related to a range of magnitude of power consumption in the port.

### (Supplementary Note 5)

The network apparatus according to any one of Supplementary notes 1 to 4, wherein the predetermined control processing is processing of cutting off communication between the target apparatus and another predetermined apparatus via the network apparatus, or processing of cutting off communication between the target apparatus and another predetermined network via the network apparatus.

### (Supplementary Note 6)

The network apparatus according to any one of Supplementary notes 1 to 5, wherein the network apparatus connects a local area network (LAN) to which the target apparatus belongs, to another LAN by a virtual private network (VPN).

### (Supplementary Note 7)

A control method to be executed by a network apparatus including a port, the control method comprising:
a computation step of computing a communication feature value related to communication between the port and a target apparatus connected to the port;
a determination step of determining whether a communication feature value computed for the target apparatus and a communication feature value predetermined for a specific apparatus match each other; and
a control execution step of performing predetermined control processing when it is determined that the communication feature value for the target apparatus and the communication feature value for the specific apparatus do not match each other.

### (Supplementary Note 8)

The control method according to Supplementary note 7, wherein the communication feature value represents a feature of a response time associated with a command that is transmitted from the network apparatus to the target apparatus.

### (Supplementary Note 9)

The control method according to Supplementary note 7, wherein the communication feature value represents a feature of a waveform of magnitude of a current in the port.

### (Supplementary Note 10)

The control method according to Supplementary note 7, wherein the communication feature value represents a feature related to a range of magnitude of power consumption in the port.

### (Supplementary Note 11)

The control method according to any one of Supplementary notes 7 to 10, wherein the predetermined control processing is processing of cutting off communication between the target apparatus and another predetermined apparatus via the network apparatus, or processing of cutting off communication between the target apparatus and another predetermined network via the network apparatus.

### (Supplementary Note 12)

The control method according to any one of Supplementary notes 7 to 11, wherein the network apparatus connects a local area network (LAN) to which the target apparatus belongs, to another LAN by a virtual private network (VPN).

### (Supplementary Note 13)

A computer readable medium storing a program to be executed by a network apparatus including a port, the program causing the network apparatus to execute:
a computation step of computing a communication feature value related to communication between the port and a target apparatus connected to the port;
a determination step of determining whether a communication feature value computed for the target apparatus and a communication feature value predetermined for a specific apparatus match each other; and
a control execution step of performing predetermined control processing when it is determined that the communication feature value for the target apparatus and the communication feature value for the specific apparatus do not match each other.

### (Supplementary Note 14)

The computer readable medium according to Supplementary note 13, wherein the communication feature value represents a feature of a response time associated with a command that is transmitted from the network apparatus to the target apparatus.

### (Supplementary Note 15)

The computer readable medium according to Supplementary note 13, wherein the communication feature value represents a feature of a waveform of magnitude of a current in the port.

### (Supplementary Note 16)

The computer readable medium according to Supplementary note 13, wherein the communication feature value represents a feature related to a range of magnitude of power consumption in the port.

### (Supplementary Note 17)

The computer readable medium according to any one of Supplementary notes 13 to 16, wherein the predetermined control processing is processing of cutting off communication between the target apparatus and another predetermined apparatus via the network apparatus, or processing of cutting off communication between the target apparatus and another predetermined network via the network apparatus.

### (Supplementary Note 18)

The computer readable medium according to any one of Supplementary notes 13 to 17, wherein the network apparatus connects a local area network (LAN) to which the target apparatus belongs, to another LAN by a virtual private network (VPN).

### REFERENCE SIGNS LIST

10 TARGET APPARATUS
20 PORT
500 COMPUTER
502 BUS
504 PROCESSOR
506 MEMORY
508 STORAGE DEVICE
510 INPUT/OUTPUT INTERFACE
512 PORT
514 CURRENT SENSOR
516 VOLTAGE SENSOR
2000 NETWORK APPARATUS
2020 COMPUTATION UNIT
2040 DETERMINATION UNIT
2060 CONTROL EXECUTION UNIT

What is claimed is:

1. A network apparatus, comprising:
at least one port;
at least one memory storing instructions;
at least one processor that is configured to execute the instructions to:
compute a communication feature value related to communication between the port and a target apparatus connected to the port;
determine whether a communication feature value computed for the target apparatus and a communication feature value predetermined for a specific apparatus match each other; and
perform predetermined control processing when it is determined that the communication feature value for the target apparatus and the communication feature value for the specific apparatus do not match each other.

2. The network apparatus according to claim 1, wherein the communication feature value represents a feature of a response time associated with a command that is transmitted from the network apparatus to the target apparatus.

3. The network apparatus according to claim 1, wherein the communication feature value represents a feature of a waveform of magnitude of a current in the port.

4. The network apparatus according to claim 1, wherein the communication feature value represents a feature related to a range of magnitude of power consumption in the port.

5. The network apparatus according to claim 1, wherein the predetermined control processing is processing of cutting off communication between the target apparatus and another predetermined apparatus via the network apparatus, or processing of cutting off communication between the target apparatus and another predetermined network via the network apparatus.

6. The network apparatus according to claim 1, wherein the network apparatus connects a local area network (LAN) to which the target apparatus belongs, to another LAN by a virtual private network (VPN).

7. A control method to be executed by a network apparatus including a port, the control method comprising:
computing a communication feature value related to communication between the port and a target apparatus connected to the port;
determining whether a communication feature value computed for the target apparatus and a communication feature value predetermined for a specific apparatus match each other; and
performing predetermined control processing when it is determined that the communication feature value for the target apparatus and the communication feature value for the specific apparatus do not match each other.

8. The control method according to claim 7, wherein the communication feature value represents a feature of a response time associated with a command that is transmitted from the network apparatus to the target apparatus.

9. The control method according to claim 7, wherein the communication feature value represents a feature of a waveform of magnitude of a current in the port.

10. The control method according to claim 7, wherein the communication feature value represents a feature related to a range of magnitude of power consumption in the port.

11. The control method according to claim 7, wherein the predetermined control processing is processing of cutting off communication between the target apparatus and another predetermined apparatus via the network apparatus, or processing of cutting off communication between the target apparatus and another predetermined network via the network apparatus.

12. The control method according to claim 7, wherein the network apparatus connects a local area network (LAN) to which the target apparatus belongs, to another LAN by a virtual private network (VPN).

13. A computer readable medium storing a program to be executed by a network apparatus including a port, the program causing the network apparatus to execute:
computing a communication feature value related to communication between the port and a target apparatus connected to the port;
determining whether a communication feature value computed for the target apparatus and a communication feature value predetermined for a specific apparatus match each other; and
performing predetermined control processing when it is determined that the communication feature value for the target apparatus and the communication feature value for the specific apparatus do not match each other.

14. The computer readable medium according to claim 13, wherein the communication feature value represents a feature of a response time associated with a command that is transmitted from the network apparatus to the target apparatus.

15. The computer readable medium according to claim 13, wherein the communication feature value represents a feature of a waveform of magnitude of a current in the port.

16. The computer readable medium according to claim 13, wherein the communication feature value represents a feature related to a range of magnitude of power consumption in the port.

17. The computer readable medium according to claim 13, wherein the predetermined control processing is processing of cutting off communication between the target apparatus and another predetermined apparatus via the network apparatus, or processing of cutting off communication between the target apparatus and another predetermined network via the network apparatus.

18. The computer readable medium according to claim 13, wherein the network apparatus connects a local area network (LAN) to which the target apparatus belongs, to another LAN by a virtual private network (VPN).
